(19) United States
(12) Patent Application Publication
(10) Pub. No.: US 2023/0368762 A1
(43) Pub. Date: Nov. 16, 2023

(54) ELECTRONIC PERCUSSION INSTRUMENT

(71) Applicant: Kuljit BHAMRA, Southall (GB)

(72) Inventor: Kuljit BHAMRA, Southall (GB)

(21) Appl. No.: 18/029,742

(22) PCT Filed: Sep. 30, 2021
(86) PCT No.: PCT/EP2021/077011

§ 371 Date: Mar. 31, 2023

(30) Foreign Application Priority Data
Oct. 8, 2020 (GB) 2015949.7

(51) Int. Cl. G10H 3/14; G10D 13/10; G10D 13/02; G10D 13/20

(52) U.S. Cl. CPC G10H 3/146; G10D 13/26; G10D 13/02; G10D 13/20; G10H 2220/525; G10H 2220/201; G10H 2230/281

(57) ABSTRACT

An electronic percussion instrument includes a base and a drumhead mounted resiliently on the base so as to be movable relative to the base. A plurality of sensors to detect movement of the drumhead relative to the base are spaced about the drumhead at selected positions to measure displacement of the drumhead relative to the base at said selected positions. At least some of said sensors are adjacent the rim of the drumhead and are responsive to movement of the rim of the drumhead towards and away from the base. The individual sensors respond to the movement at their location and the individual responses of the plurality of sensors are simultaneously measured and compared to determine the location of a hit on the drumhead, the force of the hit, and/or the duration of the hit.

### CROSS-REFERENCE TO RELATED APPLICATION(S)

This is a National Stage Entry into the United States Patent and Trademark Office from International Patent Application No. PCT/EP2021/077011, filed on Sep. 30, 2021, which relies on and claims priority to United Kingdom Patent Application No. GB 2015949.7, filed on Oct. 8, 2020, the entire contents of both of which are incorporated herein by reference.

### FIELD OF THE INVENTION

The present invention relates to an electronic percussion instrument, particularly but not exclusively, in the form of a drum intended to be played by being struck or stroked manually, the strikes or strokes being converted electronically into audio signals.

### SUMMARY OF THE INVENTION

According to the present invention there is provided an electronic percussion instrument comprising a base and a drumhead mounted resiliently on the base so as to be movable relative to the base, a plurality of sensors to detect movement of the drumhead relative to the base, the sensors being spaced about the drumhead at selected positions to measure displacement of the drumhead relative to the base at said selected positions.

In a preferred embodiment, the drumhead is substantially circular and has a peripheral rim through which the drumhead is mounted on the base through a resilient connection. The resilient connection preferably comprises a plurality of resilient elements disposed about the rim and in a preferred embodiment comprises a plurality of resilient elongate arms disposed about the rim of the drumhead and connected to the base.

In a further preferred embodiment, at least part of each of the resilient arms is displaced laterally from the longitudinal axis extending between the two junction points of the arm on the base and the drumhead.

In another embodiment, at least one sensor is positioned to measure displacement of the centre of the drumhead towards and away from the base.

In a further embodiment, at least some of said plurality of said sensors are spaced about and adjacent the rim of the drumhead to be responsive to movement of the rim of the drumhead towards and away from the base.

In a preferred embodiment, in response to movement of the drumhead on being struck or stroked, the individual sensors of the plurality respond to the movement at their location and the individual responses of the plurality of sensors are simultaneously measured and compared to determine the location of a hit on the drumhead, the force of the hit and/or the duration of the hit.

Preferably, the sensors comprise optical sensors arranged to determine the distance between the base and the drumhead to be responsive to movement of the drumhead towards and away from the base. The sensors are preferably mounted on the base.

In a preferred embodiment, the instrument comprises an acoustic drum and may comprise two drumheads, which may be of different sizes, mounted on the base.

### BRIEF DESCRIPTION OF THE DRAWINGS

A preferred embodiment of the present invention will now be described by way of example with reference to the accompanying drawings, in which:

FIG. 1 illustrates a plan view of a electronic percussion instrument comprising two drumheads,

FIG. 2 illustrates a side view of the instrument shown in FIG. 1,

FIG. 3 illustrates an exploded sectional view along the line B-B of FIG. 2,

FIG. 4 illustrates a part exploded sectional view along the line C-C of FIG. 1,

FIG. 5 illustrates a perspective, part exploded, view of the instrument,

FIG. 6 illustrates a plan view of part of the base of a single drum instrument, showing the position of optical sensors, and

FIG. 7 illustrates a resilient connection of a single drumhead for connecting a drumhead to a base.

### DESCRIPTION OF EMBODIMENT(S) OF THE INVENTION

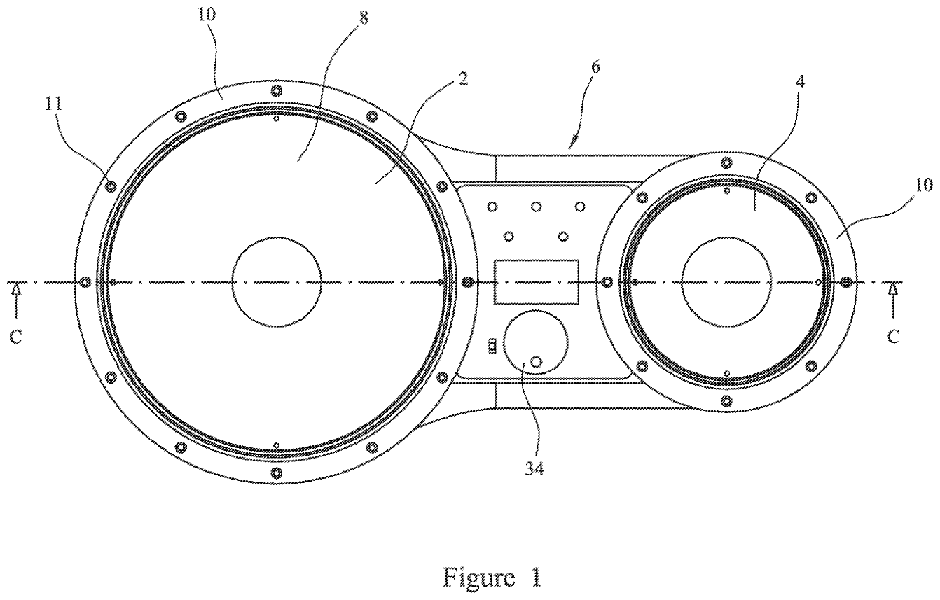

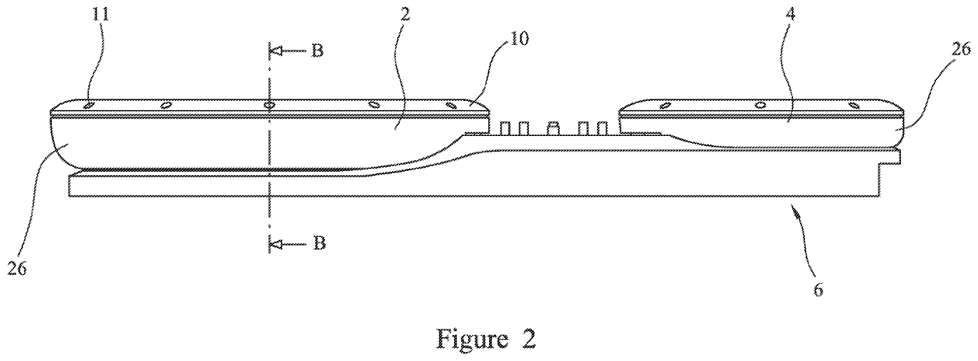

Referring now to FIG. 1 and FIG. 2, FIG. 1 illustrates a plan view of an electronic percussion instrument having two drumheads, a larger drumhead 2 and a smaller drumhead 4 mounted on a base 6. It will be understood that an instrument having two drumheads is described merely by way of illustration. A single drumhead could be provided or multiple drumheads could be provided to form a full drum set.

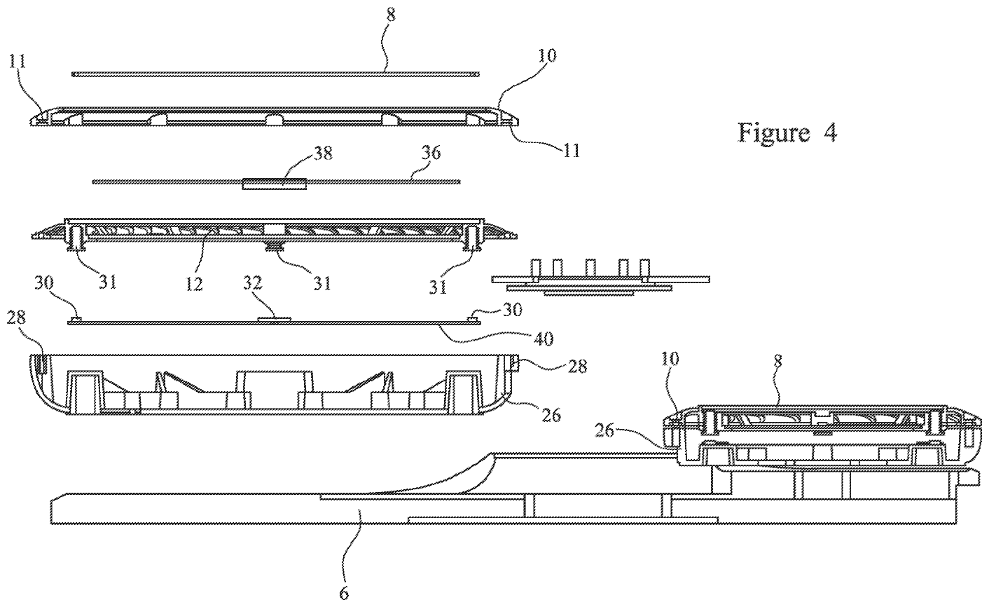

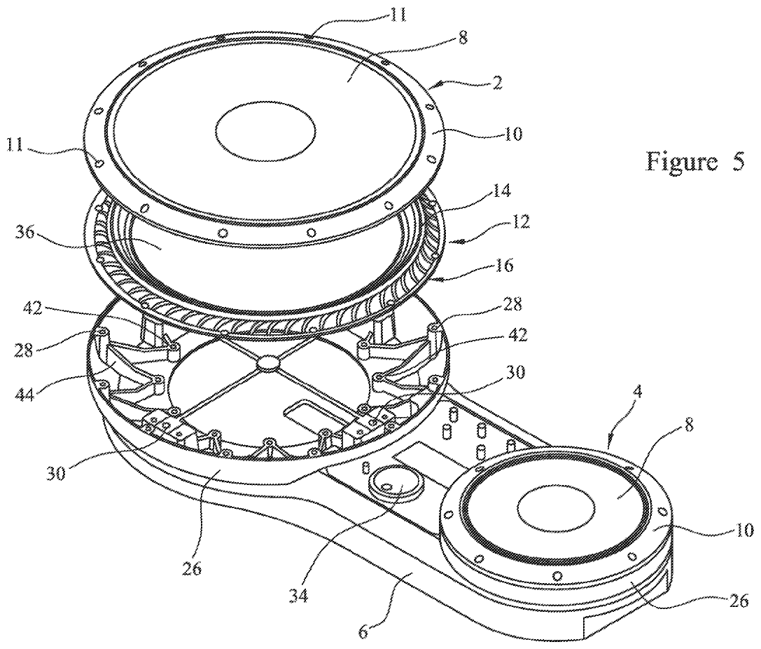

FIG. 4 shows a sectional side view of a two drumhead instrument having a larger drumhead shown in exploded form. Referring now to FIG. 5 also, there is shown a perspective view of the instrument with the larger drumhead 2 shown in exploded form. The construction of the two drumheads 2, 4, and their connection to the base 6 are substantially identical, only the size and details consequent upon the change in size being different.

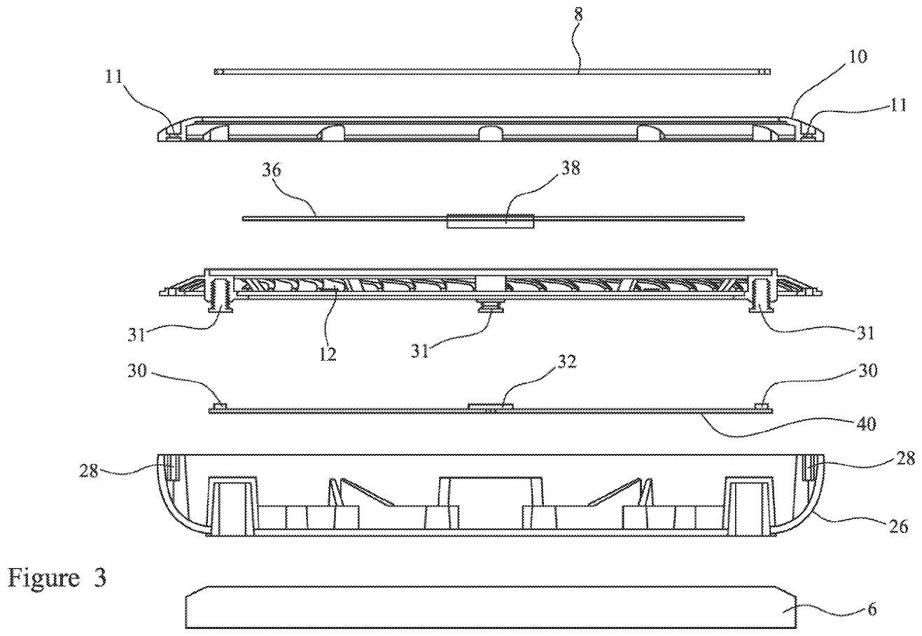

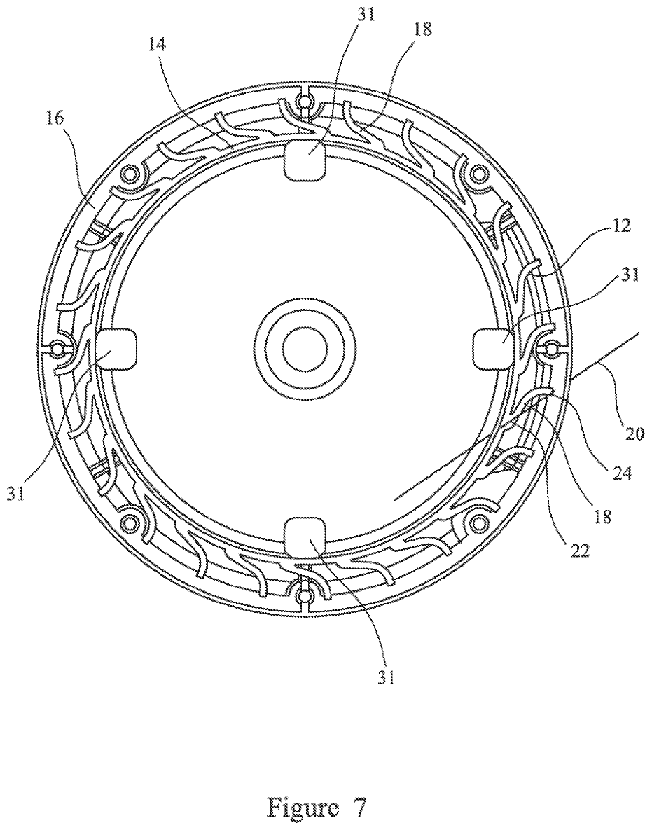

Referring now to FIG. 3 also, the drumhead 2 comprises a drum surface 8 which may be formed of a traditional drum skin but may equally be formed of a relatively inflexible material such as a plastics material. The drum surface 8 is secured to a substantially rigid peripheral ring 10 secured to the base 6 through a resilient connection 12. A plan view of the resilient connection 12 is shown in FIG. 7.

The resilient connection 12 comprises an annular member having a substantially rigid inner ring 14 joined to a concentric substantially rigid outer ring 16 through a resilient connection which in this embodiment is in the form of elongate arms 18 distributed around the periphery of the connection. The drum surface 8 is secured to the inner ring 14 In this embodiment the rings 14 and 16 and the arms 18 are formed integrally in a moulded plastics material. In alternative embodiments, the inner and outer rings 14, 16 are formed of a metal such as aluminium and the arms 18 are formed of a resilient material such as a rubber or synthetic plastics material bonded to the rings 14, 16.

As shown in FIG. 7, each arm has a longitudinal axis 20 extending at angle to a radial axis of the rings 14,16 from junctions 22 on the inner ring 14 to junctions 24 on the outer ring 16 so that the two junctions are displaced in the circumferential direction, effectively giving the arms greater length and thus greater flexibility. In the interests of clarity the references to only one arm are shown, but essentially all arms have the same structure. Furthermore, as can be seen more clearly in FIGS. 5 and 7, the arms 18 are further shaped to be displaced laterally out of the axis 20 to provide greater length and resilience. Thus the arms are shaped to give the desired degree of movement and rate of movement of the drumhead 2, 4 relative to the base 6 in response to being struck or stroked.

The drumhead 2 is secured to the base part 26 through the resilient connection 12 in which the peripheral ring 10 of the drumhead 2 is secured to the base part and also clamps the outer ring 16 of the resilient connection to the base part 26 by screws passing through holes 11 disposed about the periphery of the ring 10 and being screwed into threaded bores 28 in bosses on the base part 26 as shown in FIG. 5. Thus, the drumhead 2 and base part 26 are secured coaxially together through the resilient connection.

As shown in FIGS. 3 and 5, a piezo plate 36 is secured to a further ring secured to the inner ring 14 or to an extension of the inner ring 14 for movement therewith, but separate from the drum head. The piezo plate 36 has a piezo sensor 38 mounted on the axis of the drum head so as to be responsive to vibrations of the drumhead assembly, although it could be mounted elsewhere on the assembly.

As described earlier, the smaller drumhead 4 is constructed in the same manner as the larger drumhead 2 as described above. In a preferred embodiment, the instrument can be arranged to form a Tabla, the larger drumhead forming a bass drum and the smaller a treble drum.

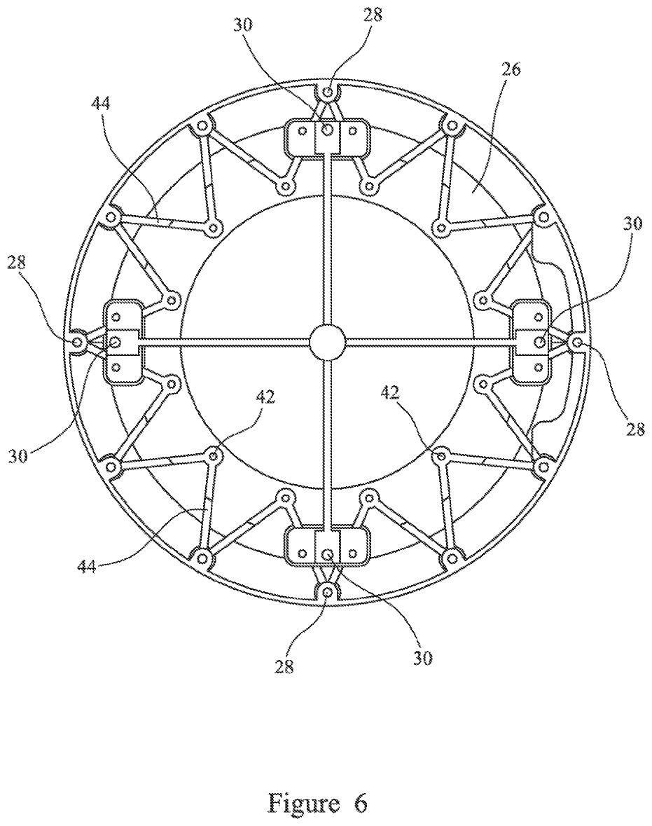

Referring now to FIGS. 5 and 6, there is shown a plurality of bosses having screw holes 42 by which the base part 26 is secured by screws to the base 6. Strengthening ribs 44 extend between the screw holes 42 and the threaded bores 28 to stiffen the base part 26. As described earlier, the instrument is played by manually striking or stroking the drum surface. These actions cause the drum head to be moved against the resilient bias of the resilient connection 12 and this movement and/or the force and duration of impact is detected by movement and force sensors 30 and converted to audio signals. To this end, in this embodiment, four sensors 30 are mounted on the base part 26 equidistantly disposed about the periphery to lie adjacent the peripheral region of the drum surface and in contact with the underside of the drum surface so as to be responsive to movement of the drumhead 2 and to give a signal representative of the movement. In this embodiment, the sensors 30 are optical sensors mounted on a board 40 such as a PCB or similar secured to the base part 26 so the signals are transmitted to a control device 34 mounted on the base 6. Their optical signals are is directed to reflectors 31 mounted on the underside of the drumhead 2 as shown in FIG. 3. Their output signals are thus representative of changes in the distances between the sensors 30 and the respective reflectors 31 at different parts of the drumhead to provide an indication of the force and duration of impact and the speed and amount of the movement at different parts of the drumhead without there being any mechanical connection between the sensors 30 and the drumhead 2. In alternative constructions, the sensors may be piezo sensors which have a direct mechanical connection between the sensors 30 and the drumhead 2, or any type of movement or force detecting sensor. The mounting position of the reflectors 31 is adjustable to vary the distance between the sensors 30 and the reflectors 31 to enable the drum output signals and hence the audio output to be tuned.

Furthermore, a further sensor 32 is located on the base on the axis of the drumhead to be responsive to vibration of the drumhead at this central location although it could be mounted elsewhere on the drumhead. This sensor 32 is, in this embodiment, a piezo sensor, but other types of sensor such as optical could be used in other embodiments. It is also possible to have a different number of the optical sensors disposed about the periphery of the drumhead such as three or five.

Output signals from the sensors are transmitted through a solid-state analogue to digital control device programmed with the appropriate software to give an output signal indicative of the output of loads applied to the drumhead surface 8, and by comparing the signals from the different sensors 30 and the sensor 32, the position of such loads on the drumhead surface. The output signal is converted to an audio signal which, in turn, is transmitted to an amplifier or other known means of producing sound representative of a hit. The software contains programs to convert the audio signal to a desired type of sound. Also, a control device 34 on the base allows the user to select the appropriate sound. Furthermore, the software can vary the sound emanating from a particular hit depending on the zone on the drumhead surface where the hit is made. In this way, the movement of the rim of the drumhead and the surface of the drumhead can be used to determine where the drumhead has been hit, how hard it has been hit and how long it has been hit, known as after-touch.

In operation, any movement or load on the drumhead, or drumheads, is subjected to a hit detection process which measures any change in the output of the sensors from their current set value. Every time a new set of values is read from the sensors, both optical and piezo, indicative of any movement or load on the drumhead, the new set of values is checked to see whether a hit has occurred after it has been subjected to a filtering process to reduce transient noise.

The first step in the hit detection process checks to see if the incoming signal has exceeded a certain threshold. If so, the maximum and minimum values for each sensor are stored over a specific time window. The maximum values are then checked to see if a potential hit has taken place. The software also subjects the potential hit to checks, which may be 3 separate checks, in order to remove crosstalk and transient signals. If a potential hit is deemed to be valid it is assigned a hit strength based on the maximum optical sensor value detected, and a position on the drumhead for the hit is determined by geometric analysis of the 4 optical sensor values to determine X and Y coordinates of the hit. To determine the position of the hit the maximum values found within the hit detection window are used. This function can also be used to determine the current position of a hand resting on the drum by using the same geometric system.

1. An electronic percussion instrument comprising a base and a drumhead mounted resiliently on the base so as to be movable relative to the base, a plurality of sensors to detect movement of the drumhead relative to the base, the sensors being spaced about the drumhead at selected positions to measure displacement of the drumhead relative to the base at said selected positions.

2. An electronic percussion instrument according to claim 1, wherein the drumhead is substantially circular and has a peripheral rim through which the drumhead is mounted on the base through a resilient connection.

3. An electronic percussion instrument according to claim 2, wherein the resilient connection comprises a plurality of resilient elements disposed about the rim.

4. An electronic percussion instrument according to claim 1, including at least one sensor positioned to measure displacement of the center of the drumhead towards and away from the base.

5. An electronic percussion instrument according to claim 1, wherein at least some of said plurality of said sensors are spaced about and adjacent the rim of the drumhead to be responsive to movement of the rim of the drumhead towards and away from the base.

6. An electronic percussion instrument according to claim 1, wherein, in response to movement of the drumhead, the individual sensors of the plurality respond to the movement at their location and the individual responses of the plurality of sensors are simultaneously measured and compared to determine the location of a hit on the drumhead, the force of the hit and/or the duration of the hit.

7. An electronic percussion instrument according to claim 1, wherein the sensors comprise optical sensors arranged to determine the distance between the base and the drumhead in response to movement of the drumhead.

8. An electronic percussion instrument according to claim 1, wherein the sensors are mounted on the base.

9. An electronic percussion instrument according to claim 1, wherein the resilient mounting of the drumhead on the base comprises a plurality of resilient elongate arms disposed about the rim of the drumhead and connected to the base.

10. An electronic percussion instrument according to claim 9, wherein each arm has a longitudinal axis extending at an angle to a radial axis of the drumhead so that the junctions of the arms with the base and drumhead are circumferentially displaced.

11. An electronic percussion instrument according to claim 10, wherein at least part of each of the resilient arms is displaced laterally from the longitudinal axis extending between the two junction points of the arm on the base and the drumhead.

12. An electronic percussion instrument according to claim 1, wherein the instrument comprises an acoustic drum.

13. An electronic percussion instrument according to claim 1, wherein the instrument comprises two drumheads mounted on the base.

14. An electronic percussion instrument according to claim 12, wherein the instrument comprises two drumheads of different sizes.
